(19) United States
(12) Patent Application Publication
(10) Pub. No.: US 2024/0093336 A1
(43) Pub. Date: Mar. 21, 2024

(54) PRINTABLE AND SINTERABLE CEMENTED CARBIDE AND CERMET POWDERS FOR POWDER BED-BASED ADDITIVE MANUFACTURING

(71) Applicant: GLOBAL TUNGSTEN & POWDERS CORP., Towanda, PA (US)

(72) Inventors: Ravi Enneti, Towanda, PA (US); Thomas Wolfe, Towanda, PA (US); Juan R. L. Trasorras, Sayre, PA (US)

(21) Appl. No.: 17/767,513

(22) PCT Filed: Oct. 9, 2020
(86) PCT No.: PCT/US2020/054953

§ 371 Date: Apr. 8, 2022

Related U.S. Application Data
(60) Provisional application No. 62/913,998, filed on Oct. 11, 2019.

(51) Int. Cl. C22C 29/08; B22F 10/14; B22F 10/64; B33Y 10/00; B33Y 70/10; C22C 1/051; C22C 29/00

(52) U.S. Cl. CPC C22C 29/08; B22F 10/14; B22F 10/64; B33Y 10/00; B33Y 70/10; C22C 1/051; C22C 29/005; B22F 2201/013; B22F 2201/11; B22F 2202/13; B22F 2301/15; B22F 2302/10; B22F 2304/10; B22F 2998/10; B22F 2999/00

(57) ABSTRACT

Disclosed herein is a method of that densifies spherodized granules having tungsten carbide and a metallic binder phase in a plasma, thereby producing densified spherodized granules.

### CROSS-REFERENCE TO RELATED APPLICATIONS

This application claims the benefit of U.S. Provisional Application No. 62/913,998 filed Oct. 11, 2019, which is incorporated herein by reference in its entirety.

### BACKGROUND

### Technical Field

This invention relates to additive manufacturing, and more particularly to the manufacture of cemented carbide components using three-dimensional (3D) printing processes based on powder bed systems.

### Technical Background

Three dimensional (3D) printing or additive manufacturing is a promising manufacturing technique that makes it possible to print a three dimensional body from a powder. A model of the body is typically created in a computer program and this model is then printed in a three dimensional printing machine or apparatus, a so-called a 3D printer. Three dimensional printing is a promising manufacturing technique because it makes it possible to produce complex structures and bodies that cannot be achieved via conventional manufacturing processes.

One type of three dimensional printing is based on binder jetting wherein an ink jet type printer head is used to spray binder onto a thin layer of powder, which, when set, forms a sheet of glued together powder for a given layer of an object. After the binder is set, a next thin layer of powder is spread over the original layer, and the printed jetting of binder is repeated in the pattern for that layer. The powder that was not printed with the binder remains where it was originally deposited and serves as a foundation and as support for the printed structure. When printing of the object is complete, the binder is cured at an increased temperature and subsequently the powder not printed with binder is removed by for example an air stream or brushing.

Cermet and cemented carbide materials consist of hard constituents of carbides and/or nitrides such as WC or TiC in a metallic binder phase of for example Co. These materials are useful in high demanding applications due to their high hardness and high wear resistance in combination with a high toughness. Examples of areas of application are cutting tools for metal cutting, drill bits for rock drilling and wear parts.

There is a need to find a successful method of three dimensional printing of cermet and cemented carbide bodies. One of the difficulties is that the final product needs to be very homogeneous in structure and in composition. Another is that the density of pores needs to be very limited.

Disclosed herein is a powder and method of producing same suitable for 3D printing of bodies like cutting tools. Also disclosed herein are the produced granules, powder mixtures, and bodies.

### SUMMARY

In accordance with the purpose(s) of the invention, as embodied and broadly described herein, this disclosure, in one aspect, relates to a method of densifying spherodized granules to make a powder mixture suitable for 3D printing.

In one aspect, disclosed herein is a method comprising: a) densifying spherodized granules comprising tungsten carbide and a metallic binder phase in a plasma, thereby producing densified spherodized granules.

Also disclosed herein is a method comprising: 3D printing a body from a composition comprising a powder mixture comprising the densified spherodized granules disclosed herein and a printing binder. The method can further comprise the step of sintering the body, thereby producing a cemented carbide body or a cermet body.

Also disclosed herein is a powder mixture comprising the densified spherodized granules that can be produced by the methods disclosed herein.

Also disclosed herein is a cemented carbide body or a cermet body that can be produced by the methods disclosed herein.

Also disclosed herein is a three-dimensional printed body of cemented carbide or cermet, wherein it has a duplex microstructure.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIGS. 1A-1F shows SEM micrographs showing the spherical morphology of AM WC-A (FIGS. 1A and 1B), AM WC-B (FIGS. 1C and 1D) and WC-C (FIGS. 1E and 1F) powders.

FIGS. 2A-2D shows microstructures of samples made from powders AM WC-A (FIGS. 2A and 2B) and AM WC-B (FIGS. 2C and 2D) after sintering at 1,400° C. for 30 minutes.

FIG. 3 shows volume loss in the ASTM B611 abrasion wear test as a function of fracture toughness for cemented carbides with varying Co contents [I. Konyashin, B. Int. J. Refract. Met. Hard Mater. 49 (2015) 203-211].

FIGS. 4A-4D shows microstructures of samples made from powders AM WC-C (FIGS. 4A and 4B) and AM WC-D (FIGS. 4C and 4D) after sintering at 1,435° C. for 30 minutes.

FIGS. 5A-5F shows microstructures of samples made from powders AM WC—C sintered in vacuum at 1,375° C. (FIGS. 5A and 5B), 1,400° C. (FIGS. 5C and 5D) and 1,435° C. (FIGS. 5E and 5F).

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

### Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a fraction” or “a composition” includes blends of two or more fractions, or presence of two or more compositions, respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

As used herein, the terms “optional” or “optionally” means that the subsequently described event or circumstance can or can not occur, and that the description includes instances where said event or circumstance occurs and instances where it does not.

As used herein, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a powder mixture, composition or component of a composition that is substantially absent, is intended to refer to an amount that is than about 1% by weight, e.g., less than about 0.5% by weight, less than about 0.1% by weight, less than about 0.05% by weight, or less than about 0.01% by weight of the stated material, based on the total weight of the composition.

References in the specification and concluding claims to parts by weight of a particular element or component in a composition or article, denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5, and are present in such ratio regardless of whether additional components are contained in the composition.

A weight percent of a component, unless specifically stated to the contrary, is based on the total weight of the formulation or composition in which the component is included.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions; and it is understood that there are a variety of structures that can perform the same function that are related to the disclosed structures, and that these structures will typically achieve the same result.

Unless specifically referred to the contrary herein, terms tungsten carbide or WC are used interchangeably and are intended to refer to any form of tungsten carbide.

The term “cemented carbide” is herein means a material comprising hard constituents in a metallic binder phase, wherein the hard constituents comprise WC grains. The hard constituents can also comprise carbides or carbonitrides of one or more of Ta, Ti, Nb, Cr, Hf, V, Mo and Zr, such as TiN, TiC and/or TiCN.

The term “cermet” is herein intended to denote a material comprising hard constituents in a metallic binder phase, wherein the hard constituents comprise carbides or carbonitrides of one or more of Ta, Ti, Nb, Cr, Hf, V, Mo and Zr, such as TiN, TiC and/or TiCN.

The metallic binder phase in the cemented carbide or the cermet is a metal or a metallic alloy, and the metal can for example be selected from Cr, Mo, Fe, Co or Ni alone or in any combination. Preferably the metallic binder phase comprises a combination of Co, Ni and Fe, a combination of Co and Ni, or only Co. The metallic binder phase can comprise other suitable metals as known to one of skill in the art.

The particle size distribution (PSD) is herein presented by D-values, such as D10, D50, and D90 values. The D50, the median, is defined as the particle diameter where half of the population has a size smaller than this value. Similarly, 90 percent of the distribution is smaller than the D90 value, and 10 percent of the population is smaller than the D10 value.

The following acronyms are used herein:
3D=Three-dimensional
BJ3DP=Binder Jet 3D Printing
FSSS=Fisher Sub-Sieve Size
LOM=Light Optical Microscopy
PEG=polyethylene glycol
PM=Powder Metallurgy
PSD=Particle Size Distribution

Unless specifically referred to the contrary herein, Transverse Rupture Strength (TRS) is intended to refer to the stress in a material just before it yields in a flexural test.

### Method, Powder Mixture, and 3D Printed Body

Cemented carbides exhibit high hardness and wear resistance at high temperature, in combination with good toughness. This unusual combination of properties is achieved by combining a hard and brittle carbide phase(s) with a ductile and deformable binder.

With few exceptions, the main component of cemented carbides is tungsten carbide (WC). Carbides, nitrides, or carbonitrides of Ti, Nb, Ta, and Hf can also be present as mixed crystal formers. The hard material phases are bonded together by a ductile metallic phase that surrounds them (cemented carbides), usually Co, more rarely Ni or Fe alloys.

By varying the carbide/binder ratio, and by suitable choice of the carbide composition, the properties can be varied within wide limits. A further control parameter for certain properties is the microstructure, i.e., the grain size of the carbide phase(s), which can be controlled via the particle size of the powder used, the powder milling, and the sintering conditions.

The most important groups of applications of cemented carbides are: 1. Metal cutting tools for drilling, turning, milling; 2. Tools for processing wood and plastics; 3. Drilling tools in mining and mineral oil and water drilling technology; 4. Wear-resistant components in a wide range of machinery (a continuously increasing group with the widest diversification); and 5. Elastically bonded abrasive materials.

The conventional manufacture of hard metals is based on powder metallurgical techniques, which include several steps. Each step must be carefully controlled to achieve a final product with the desired properties. These steps are: 1. Preparation of WC powder; 2. Preparation of other carbide powders; 3. Production of grade powders (blending, powder milling, granulation); 4. Powder consolidation (in dies or via cold isostatic pressing); 5. Liquid-phase sintering; and 6. Post sinter operations (grinding, coating, etc.).

Recently, additive manufacturing (AM) has emerged as a potential production process for cemented carbides. Additive manufacturing refers to several technologies that produce parts in an additive way. The starting point is a digital 3D model of a part which is then sliced in thin layers by computer software. An additive manufacturing machine builds the part from this series of layers—each one applied directly on top of the previous one [Ian Gibson, Additive manufacturing technologies: 3D printing, rapid prototyping, and direct digital manufacturing: Springer, 2014].

This definition is broadly applicable to all classes of materials including metals, ceramics, polymers, composites and biological systems. While AM has been around as a means of processing materials for, arguably, over two decades, it has only recently (2010) begun to emerge as an important commercial metals manufacturing technology.

The potential advantages of applying AM to the manufacturing of cemented carbides include: 1. Eliminates the need for compaction tooling; a. Compaction in dies is a cost—effective method for high volume production. However, tooling costs are high, and the process becomes expensive for low production volumes; b. Lead times for tooling production are long, typically several weeks: 2. Allows the net or near-net shape production of complex shapes that are not realizable by pressing in dies: and 3. For low volume production, it can also be competitive against cold isotactic pressing of a blank followed by green machining and sintering.

Many issues must be resolved before this potential can be realized. In fact, today (2019), there is no commercial production of cemented carbide by AM.

Of all the different AM technologies, the processes based on powder bed systems are the most relevant. In these systems, a uniform layer of powder, typically 20-50 microns thick, is deposited on the building platform and consolidated. The powder platform descends by the layer thickness and a subsequent layer of powder is delivered and consolidated. The process is repeated until the complete part is formed [Ian Gibson, Additive manufacturing technologies: 3D printing, rapid prototyping, and direct digital manufacturing: Springer, 2014].

Two approaches have been developed to consolidate metal powders: 1) Selective laser or electron beam melting/sintering (SLM) and 2) binder jet 3D printing (BJ3DP) followed by debinding and sintering.

In SLM each layer of powder is sintered/melted by a focused laser or electron beam, immediately after each powder layer is deposited. In BJ3DP a printing head scans the surface of the powder depositing a binder on the area defined by a layer of the model. When the printing is completed the part produced is in the green state (powder particles embedded in a binder matrix) and surrounded by lose powder. The lose powder is removed (de-powdering) to expose the part. When BJ3DP is applied to metals, the green part is subsequently consolidated by thermally or chemically removing the binder, and by sintering under a proper atmosphere.

Both SLM and BJ3DP have been applied successfully to stainless steel, Ni alloys, Cu and other metals [P. Nandwana, Curr. Opin. Solid State Mater. Sci. 21, 4 (2017), 207-218; Daeho Hong, Acta biomaterialia, 45, 2016, pp. 375-386; Amir Mostafaei, Acta Materialia 124 (2017) 280-289; Yun. Bai, Rapid Protot. J. 21 (2) (2015) 177-185; J. P. Kruth, Mater. Process. Technol., 2004, vol. 149, no. 1-3, pp. 616-622; M. Fousovaa, J. Mech. Behay. Biomed, 2017, vol. 201, no. 69, pp. 368-76; E. O. Olakanmi, J. Mater. Process. Technol., 2011, vol. 211, no. 1, pp. 113-121; Y. M. Arisoy, Int. J. Adv. Manuf Tech, 2017, vol. 90, no. 5-8, pp. 1393-1417; Q. Jia J. Alloys Compd. 2014; 585:713-721]. However, application to cemented carbides has faced major challenges.

Production of cemented carbide by SLM has been attempted [Ravi K. “Direct metal laser sintering (DMLS)/selective laser melting (SLM) of WC-12% Co powders” 2018 AMPM conference, San Antonio, USA; Subrata Kumar Ghosh, “Selective Laser Sintering: A Case Study of Tungsten Carbide and Cobalt Powder Sintering by Pulsed Nd: YAG Laser,” in In Lasers Based Manufacturing. India: Springer, 2015, pp. 441-459], but the resulting microstructures had high porosity and consequently very low mechanical and wear properties, precluding any practical application.

Attempts have been reported at applying BJ3DP to the manufacture of cemented carbide components with varying degrees of success, which are summarized below.

In order to produce a successful part, the powder used for BJ3DP must meet key requirements: 1. The powder must be free flowable. That is, there is a need to consistently deliver powder layers of uniform thickness and to facilitate the de-powdering of parts with complex geometry. There is also a need that the particles must be mostly spherical to achieve a free flow. 2. The powder must have a size smaller than the printing layer thickness. The D90 typically needs to be in the range from 50 μm to 100 μm. 3. The powder must be sinterable. That is, there has to be a high packing density to enable the subsequent liquid phase sintering to full density. A low packing density results in an undesired porosity in the sintered microstructure. It is also noted that the particle size distribution (PSD) of the powder also affects sinterability. Unfortunately, 1 and 3 are competing requirements. As we explain in more detail below, efforts at increasing the packing density are often detrimental to flowability.

WC powder is produced by carburization of W powder. Co powder is produced by reduction of Co oxides under a hydrogen atmosphere. Both powders are highly irregular in shape. Irregular shape combined with small size results in a powder with very poor flow characteristics. Hence, additional processing of the WC and Co powders is needed to obtain a powder that can be successfully printed.

Stoyanov et al [U.S. 2019/0084290] proposed a process to produce spherical powder for AM. WC-Co powder is produced by milling WC powder and Co powder, adding a binder, granulating by spray drying to produce spherical granules and finally sintering the powder to increase its density, while still preserving the spherical morphology.

In Stoyanov et al [U.S. 2019/0084290] “Example 1”, a WC-17% Co powder was produced and subsequently printed by BJ3DP and sintered in vacuum. The resulting relative density was 97.7% (a large amount of porosity was present). To reduce the porosity, the parts were hot is statically pressed (HIP) at temperature of 1425° C. and pressure of 20,000 psi. Even at this high pressure, the density obtained was only 98.7%. A useful material has density >>99%.

In “Example 2”, a WC-20% article was produced. The resulting density was 96.3%. Finally, in “Example 3” a WC-12% Co article was produced. The final density was not reported, but light optical microscopy (LOM) images of the sintered microstructure show a large amount of porosity.

These examples illustrate the difficulties in achieving full density, even adding a HIP step and even for compositions with very high amount of Co (17-20%), that are easier to sinter.

Prichard et al [U.S. 2018/0236687] introduced an improvement over the Stoyanov process. In order to increase the packing density of the powder to improve sinterability, Prichard proposed to use higher temperatures in the powder sintering step. Density increases, but, unfortunately, the powder granules not only sinter internally (intra-granular sintering), but they sinter between granules (inter-granular sintering). The granules form a cake. The cake is broken up by milling. In order to further increase the density, Prichard proposes to repeat the sintering and milling steps as necessary.

In Prichard's “Example 3”, a WC-17% Co article was produced using a powder that underwent only one step of sintering and milling (impact milling), was subsequently printed by BJ3DP and sintered in vacuum at a temperature of 1,460-1,500° C. In spite of the high sintering temperature, the density obtained was only 98.7%.

In “Example 2”, a WC-17% article was produced using a powder that underwent two steps of sintering and milling (ball milling followed by impact milling), was subsequently printed by BJ3DP and underwent vacuum sinter/HIP at a temperature of 1,460-1,500° C. (necessary pressure not reported). A density of 99.3% was achieved.

Under the conditions of “Example 2”, almost full density was achieved. Nevertheless, there are many disadvantages to this process: 1. The need for two sintering and two milling steps is costly. 2. Milling the powder cake results in non-spherical powder that is detrimental to powder flowability and printing. 3. High sintering temperature is costly because it reduces furnace life. Normal practice is to keep temperature <1,450° C. 4. High sintering temperature promotes more distortion during sintering, thus reducing the dimensional capability of the process.

In another invention, Maderud et al [U.S. 2017/0072469] propose the addition of a “sintering inhibitor” to prevent the inter-granule sintering during the sintering densification of the powder. Ytrium oxide and graphite were successful inhibitors. The powder manufacturing process follows the following steps: 1. Forming spherically shaped granules comprising metal, hard constituents and organic binder by spray drying. 2. Mixing the granules with a sintering inhibitor powder. 3. Heat-treating the mixture in a furnace to remove the organic binder. 4. Sintering the powder (the hard constituents with the metal in each spherically shaped granule). 5. Separating the sintering inhibitor powder from the sintered dense spherically shaped granules by various methods (magnetic separation in the case of yttrium oxide and air classification followed by decarburization under hydrogen in the case of graphite).

Maderud reports obtaining a powder with minimal residual internal porosity in the granules and high packing density. A fully dense article was produced by encapsulating the powder and HIPing at 1,310° C. and 150 MPA.

The are some concerns about this process, primarily with respect the step to separate the cemented carbide powder from the sintering inhibitor powder. In the case of yttrium oxide, incomplete separation results in the introduction of a contaminant. In the case of graphite, the separation steps are costly.

Maderud proposes using this powder for AM, however, no results are reported. If a post sintering HIP step at 150 MPa is required, the process would be impractical for AM.

Maderud later proposed an alternative approach. A powder comprising a mixture of 70% porous cemented carbide particles and 30% dense cemented carbide particles. The rationale for this approach is that the porous particles enhance the powder sinterability and that the dense particles increase the green strength of the printed part. If the powder mixture comprises more than 35 wt % of dense particles of irregular shape, the flow of the powder mixture during printing is insufficient.

For the dense particles, Maderud used two sources: 1) Zn reclaimed WC-Co powder of irregular shape, and 2) the spherical powder produced with sintering inhibitors described above. The porous particles were produced by spray drying granules of WC, Co and binder (polyethylene glycol) followed by partial sintering.

Maderud reported six formulations (labelled A through F) of the powder. Articles were manufactured by BJ3DP followed by debinding and vacuum sintering at 1,410° C. The samples A-F were subjected to and additional HIP-sintering step at a temperature of 1,410° C. and a pressure of 5.5 MPa. In samples A and B porosity was completed eliminated. Sample D had poor green strength. Samples D-G had high amounts of residual porosity.

This two-step sintering process (vacuum sintering followed by sinter-HIP) would be too expensive for industrial production.

Disclosed herein is a method that spherodizes granules comprising tungsten carbide and a metallic binder phase to make them more suitable for 3D printing. Spherical particles have a better flowing property during the 3D printing process. The spherodized granules can be produced by spray drying. The spherodized granules can then be densified in a plasma.

Disclosed herein is a method comprising: a) densifying spherodized granules comprising tungsten carbide and a metallic binder phase in a plasma, thereby producing densified spherodized granules.

The metallic binder phase content variation can for example be measured by WDS (Wavelength-dispersive X-ray spectroscopy) or EDS (Energy-dispersive X-ray spectroscopy). Since the cermet or cemented carbide body is a composite comprising a metallic binder phase and hard constituents the binder phase content has to be measured as an average. The area needed to give a value of the binder phase content is to be selected by the skilled person but can for example be a scan width of 200 μm.

In one aspect, the densified spherodized granules can comprise at least about 75 wt % of tungsten carbide. For example, the densified spherodized granules can comprise at least about 80 wt % of tungsten carbide. In another example, the densified spherodized granules can comprise at least about 85 wt % of tungsten carbide. In yet another example, the densified spherodized granules can comprise at least about 90 wt % of tungsten carbide. In yet another example, the densified spherodized granules can comprise at least about 95 wt % of tungsten carbide. In yet another example, the densified spherodized granules can comprise from about 75 wt % to about 95 wt % tungsten carbide. In yet another example, the densified spherodized granules can comprise from about 75 wt % to about 90 wt % tungsten carbide. In yet another example, the densified spherodized granules can comprise from about 75 wt % to about 85 wt % tungsten carbide. In yet another example, the densified spherodized granules can comprise from about 80 wt % to about 85 wt % tungsten carbide.

In one aspect, the densified spherodized granules can comprise at least about 2 wt % of the metallic binder phase. For example, the densified spherodized granules can comprise at least about 5 wt % of the metallic binder phase. In another example, the densified spherodized granules can comprise at least about 8 wt % of the metallic binder phase. In yet another example, the densified spherodized granules can comprise at least about 10 wt % of the metallic binder phase. In yet another example, the densified spherodized granules can comprise at least about 12 wt % of the metallic binder phase. In yet another example, the densified spherodized granules can comprise at least about 15 wt % of the metallic binder phase. In yet another example, the densified spherodized granules can comprise at least about 17 wt % of the metallic binder phase. In yet another example, the densified spherodized granules can comprise at least about 20 wt % of the metallic binder phase. In yet another example, the densified spherodized granules can comprise from about 8 wt % to about 20 wt % tungsten carbide. In yet another example, the densified spherodized granules can comprise from about 8 wt % to about 15 wt % tungsten carbide. In yet another example, the densified spherodized granules can comprise from about 10 wt % to about 15 wt % tungsten carbide. In yet another example, the densified spherodized granules can comprise from about 4 wt % to about 10 wt % tungsten carbide.

In one aspect, the densified spherodized granules can comprise at least about 2 wt % of carbon. For example, the densified spherodized granules can comprise at least about 3 wt % of carbon. In yet another example, the densified spherodized granules can comprise at least about 4 wt % of carbon. In yet another example, the densified spherodized granules can comprise at least about 5 wt % of carbon. In yet another example, the densified spherodized granules can comprise at least about 6 wt % of carbon. In yet another example, the densified spherodized granules can comprise at least about 7 wt % of carbon.

In one aspect, the densified spherodized granules can comprise from about 75 wt % to about 94 wt % of tungsten carbide, from about 4 wt % to about 20 wt % of the metallic binder phase, and from about 2 wt % to about 7 wt % carbon. For example, the densified spherodized granules comprises from about 83 wt % to about 93 wt % of tungsten carbide, from about 4 wt % to about 10 wt % of the metallic binder phase, and from about 3 wt % to about 7 wt % carbon.

In one aspect, the metallic binder phase can comprise Cr, Mo, Fe, Co, or Ni, or a combination thereof. For example, the metallic binder phase can comprise Cr. In another example, the metallic binder phase can comprise Mo. In yet another aspect, the metallic binder phase can comprise Fe. In yet another aspect, the metallic binder phase can comprise Co. In yet another aspect, the metallic binder phase can comprise Ni.

In one aspect, the densified spherodized granules can have a particle size of D90 of less than 100 μm. For example, the densified spherodized granules can have a particle size of D90 of less than 50 μm. In another example, the densified spherodized granules can have a particle size of D90 of less than 40 μm. In another example, the densified spherodized granules can have a particle size of D90 of less than 35 μm. In another example, the densified spherodized granules can have a particle size of D90 of less than 30 μm. In yet another example, the densified spherodized granules can have a particle size of D90 of less than 25 μm. In yet another example, the densified spherodized granules can have a particle size of D90 of less than 20 μm. In yet another example, the densified spherodized granules can have a particle size of D90 of less than 15 μm. In yet another example, the densified spherodized granules can have a particle size of D90 from about 10 μm to about 50 μm. In yet another example, the densified spherodized granules can have a particle size of D90 from about 20 μm to about 40 μm.

In one aspect, the densified spherodized granules can have a bulk density of at least about 4 g/cm³. For example, the densified spherodized granules can have a bulk density of at least about 5 g/cm³. In another example, the densified spherodized granules can have a bulk density of at least about 6 g/cm³. In another example, the densified spherodized granules can have a bulk density of at least about 7 g/cm³. In another example, the densified spherodized granules can have a bulk density of at least about 8 g/cm³. In another example, the densified spherodized granules can have a bulk density of from about 4 g/cm³ to about 8 g/cm³.

Spherodized granules comprising tungsten carbide and a metallic binder can be produced by spray drying a slurry containing tungsten carbide and the metallic binder.

The spherodized granules comprising tungsten carbide and a metallic binder phase can be contacted with a plasma generated by a plasma torch, thereby being densified. Pores within the spherodized granules collapse when exposed to the plasma, thereby densifying the spherodized granules. The plasma is generated by a mixture of gases when contacted with the energy exerted by the plasma torch. The mixture of gases can vary, but typically includes H₂ and Ar. It is contemplated that other gases commonly used in plasma, such as N₂ and He also be included. The plasma can also be controlled by manipulating the power of the plasma torch. The granules comprising tungsten carbide and a metallic binder phase can be contacted with the plasma for a short period of time, typically on the microsecond scale. The plasma typically has a temperature from 3,000 K to 5,000 K. The spherodized densified granules comprising tungsten carbide and a metallic binder phase can be cooled after being exposed to the plasma, for example, by being placed in a cooled container.

Also disclosed herein, is a powder mixture comprising the densified spherodized granules comprising tungsten carbide and a metallic binder phase. The powder mixture is suitable for being used in 3D printing.

In one aspect, disclosed herein a method comprising a) 3D printing a body from a composition comprising the powder mixture disclosed herein and a printing binder.

Curing can be performed as a part of the printing step. The printing binder is cured whereby the body gets a sufficient strength. The curing can be performed by subjecting the printed body to an increased temperature, such as 150-250° C.

In one aspect, the method further comprises the step of sintering the body, thereby producing a cemented carbide body or a cermet body.

In one aspect, the sintering step can comprise a debinding step, where the printing binder is burned off. The printing binder can comprise a solvent that partly evaporates during the printing. The printing binder can be water-based.

In one aspect the three dimensional printing is performed in a three dimensional printing machine such as a binder jet three dimensional printing machine. The three dimensional printing can be binder jetting. Binder jetting is advantageous in that it is a relatively cheap three dimensional printing method.

In one embodiment the sintering described herein is performed in a sintering furnace.

In one aspect, the sintering is performed at a temperature of at least 1,200° C. For example, the sintering is performed at a temperature from about 1,300° C. to about 1,500° C.

In one aspect, the method can further comprise a step of, subsequent to or integrated into the sintering step, a step of so called sinter-HIP or GPS (gas pressure sintering) the cermet or cemented carbide body. The sinter-HIP may be performed at a temperature of 1300-1500° C. The sinter-HIP may be performed at a pressure of 20-100 bar. Subsequent to for example a normal vacuum sintering, a pressure is applied. The aim of the sinter-HIP step is to reduce any porosity left after the sintering by densifying the material. Any closed porosity in the sintered body is encapsulated and the applied pressure will reduce the porosity. Open porosity can on the other hand not be reduced using sinter-HIP.

In one aspect, the cemented carbide body or the cermet body can have a relative density of at least 99% theoretical density. For example, the cemented carbide body or the cermet body can have a relative density of at least 100.0% theoretical density. In another example, the cemented carbide body or the cermet body can have a relative density of at least 99.5% theoretical density. In another example, the cemented carbide body or the cermet body can have a relative density of at least 99.9% theoretical density.

In one aspect, the cemented carbide body or the cermet body can have a hardness of at least 83.0 Hra. For example, the cemented carbide body or the cermet body can have a hardness of at least 85.0 Hra. In another example, the cemented carbide body or the cermet body can have a hardness of at least 87.0 Hra. In another example, the cemented carbide body or the cermet body can have a hardness of at least 89.0 Hra. In another example, the cemented carbide body or the cermet body can have a hardness of at least 89.5 Hra. In another example, the cemented carbide body or the cermet body can have a hardness of at least 89.7 Hra.

In one aspect, the cemented carbide body or the cermet body can have a fracture toughness of at least 3 Mpa m^{3/2}. For example, the cemented carbide body or the cermet body can have a fracture toughness of at least 5 Mpa m^{3/2}. In another example, the cemented carbide body or the cermet body can have a fracture toughness of at least 7 Mpa m^{3/2}. In another example, the cemented carbide body or the cermet body can have a fracture toughness of at least 9 Mpa m^{3/2}. In another example, the cemented carbide body or the cermet body can have a fracture toughness of at least 11 Mpa m^{3/2}. In another example, the cemented carbide body or the cermet body can have a fracture toughness of at least 13 Mpa m^{3/2}. In another example, the cemented carbide body or the cermet body can have a fracture toughness of at least 14 Mpa m^{3/2}. In another example, the cemented carbide body or the cermet body can have a fracture toughness of at least 15 Mpa m^{3/2}. In another example, the cemented carbide body or the cermet body can have a fracture toughness of at least 16 Mpa m^{3/2}. In another example, the cemented carbide body or the cermet body can have a fracture toughness of at least 19 Mpa m^{3/2}.

In one aspect, the cemented carbide body or the cermet body can have a volume loss of less than 150 mm³ when evaluated in a ASTM B611 abrasion wear test. For example, the cemented carbide body or the cermet body can have a volume loss of less than 140 mm³ when evaluated in a ASTM B611 abrasion wear test. In another example, the cemented carbide body or the cermet body can have a volume loss of less than 130 mm³ when evaluated in a ASTM B611 abrasion wear test. In yet another example, the cemented carbide body or the cermet body can have a volume loss of less than 120 mm³ when evaluated in a ASTM B611 abrasion wear test. In yet another example, the cemented carbide body or the cermet body can have a volume loss of less than 110 mm³ when evaluated in a ASTM B611 abrasion wear test. The ASTM B611 test is carried out to evaluate the abrasion resistance of materials in high stress conditions. The test involves impingement of abrasive medium by a rotation steel wheel on the sample. A slurry containing water and alumina abrasive particles are used as the abrasive medium for the test. The ASTM B611-13 “Standard Test Method for Determining the High Stress Abrasion Resistance of Hard Materials” provides all necessary details regarding the ASTM B611 test used herein.

In one aspect, the body produced by the 3D printing can be a cutting tool for metal cutting or a cutting tool for mining application or a wear part. For example, the body produced by the 3D printing can be a cutting tool for metallic cutting such as an insert, a drill or an end mill, or a cutting tool for mining application such as a drill bit, or a wear part. In another example, the cemented carbide body or the cermet body can be a cutting tool for metallic cutting, a cutting tool for mining application, a wear part, a flow control component for oil or gas applications, or is a pump component for oil and gas applications.

Also disclosed herein is a 3D printed cermet or cemented carbide body produced by the method disclosed herein.

In one aspect, the 3D printed cermet or cemented carbide body can have a microstructure of the classification A00B00C00. In one aspect, the 3D printed cermet or cemented carbide body can have a duplex microstructure.

Printing binders suitable for 3D printing are known to those of skill in the art and can be obtained from commercial sources. The printer binder can contain a water based solvent for application. For example, one suitable printer binder is Aqueous Binder BA005 sold by ExOne. Aqueous Binder BA005 contains, in part, water, ethynediol, and 2-butoxyehanol.

In one aspect, the composition can comprise at least about 30% saturation of the printing binder. For example, the composition can comprise at least about 40% saturation of the printing binder. In another example, the composition can comprise at least about 50% saturation of the printing binder. In yet another example, the composition can comprise at least about 60% saturation of the printing binder. In another example, the composition can comprise at least about 70% saturation of the printing binder. In another example, the composition can comprise at least about 80% saturation of the printing binder. In another example, the composition can comprise at least about 90% saturation of the printing binder. In another example, the composition can comprise about 100% saturation of the printing binder. In another example, the composition can comprise from about 20% saturation to about 100% saturation of the printing binder. In another example, the composition can comprise from about 50% saturation to about 80% saturation of the printing binder. In another example, the composition can comprise from about 70% saturation to about 100% saturation of the printing binder.

In one aspect, the composition can comprise at least about 60% saturation of the powder mixture. For example, the composition can comprise at least about 50% saturation of the powder mixture. In another example, the composition can comprise at least about 40% saturation of the powder mixture. In another example, the composition can comprise at least about 30% saturation of the powder mixture. In another example, the composition can comprise at least about 20% saturation of the powder mixture. In another example, the composition can comprise less than about 60% saturation of the powder mixture. In another example, the composition can comprise less than about 50% saturation of the powder mixture. In another example, the composition can comprise less than about 40% saturation of the powder mixture. In another example, the composition can comprise less than about 30% saturation of the powder mixture. In another example, the composition can comprise less than about 20% saturation of the powder mixture. In another example, the composition can comprise from about 10% saturation to about 70% saturation of the powder mixture. In another example, the composition can comprise from about 20% saturation to about 60% saturation of the powder mixture. In another example, the composition can comprise from about 10% saturation to about 40% saturation of the powder mixture.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Example 1: To produce a WC-12% Co powder suited for the BJ3DP process, a fine WC powder (Global Tungsten & Powders Corp. SC17 with FSSS 1.1-1.4 μm) and a fine Co powder (Umicore extra fine powder with FSSS 1.2 μm) were utilized as raw materials. The WC and Co powders and polyethylene glycol (PEG) binder were milled to produce an aqueous slurry. The slurry was spray dried to produce spherical granules and followed by sintering the granules to remove the binder and to achieve some increase in the density of the granules through intra-granule sintering, while avoiding inter-granule sintering to preserve the spherical shape of the granules.

Densification process: The sintered powder was then separated into size fractions by screening; the <150 μm. fraction was fed through a powder feeder into a plasma torch and collected in water cooled tank. A mixture of gases like hydrogen, argon, and nitrogen was fed to the plasma torch.

By controlling the power input to the plasma torch, the degree of spherodization/densification of the granules was controlled. Two powder labeled “AM WC-A” and “AM WC-B” were produced. The product collected was examined for particle size distribution (PSD), bulk density and Hall flow (ASTM B213-48). The results are summarized in Table 1.

The data shows both powders exhibiting similar particle sizes and good flow characteristics. The bulk density of AM WC-A and AM WC-B were 5.0 and 6.2 g/cm³ respectively.

TABLE 1

| | Particle size (μm) | | | Bulk density | Hall flow |
|---|---|---|---|---|---|
| Sample | D10 | D50 | D90 | (g/cm³) | (s/50 g) |
| AM WC-A | 10.8 | 18.1 | 30.7 | 5.0 | 18.0 |
| AM WC-B | 10.8 | 18.1 | 30.7 | 6.2 | 19.0 |

The chemical analysis of AM WC-A and AM WC-B confirming high purity of the powders is shown in Table 2.

TABLE 2

| Element (%) | AM WC-A | AM WC-B |
|---|---|---|
| C | 5.4 | 5.3 |
| Ca | <0.3 | <0.3 |
| Co | 12.1 | 12.1 |
| Cr | <0.1 | <0.1 |
| Cu | <0.2 | 0.2 |
| Fe | <0.1 | <0.1 |
| Mn | <0.2 | <0.2 |
| Mo | <0.2 | <0.2 |
| Nb | <0.2 | <0.2 |
| Ni | <0.1 | <0.1 |
| P | <0.1 | <0.1 |
| Ta | <0.2 | <0.2 |
| Ti | <0.3 | <0.3 |
| W | 82.5 | 82.6 |
| Zr | <0.1 | <0.1 |

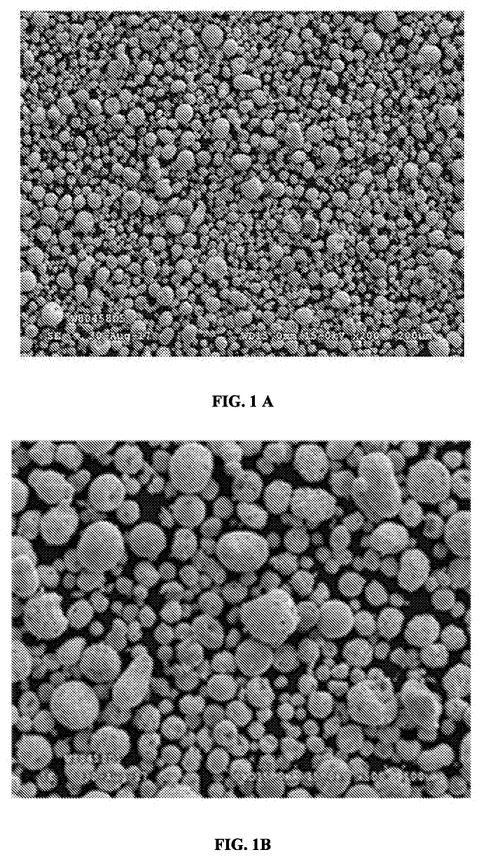

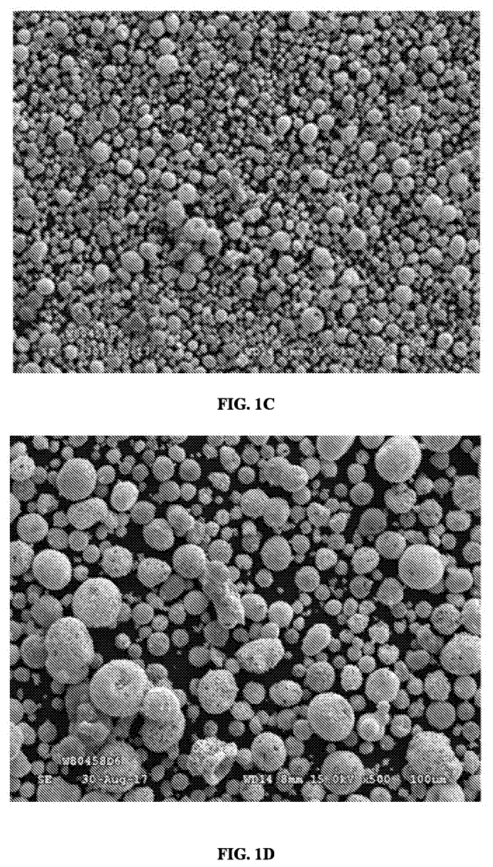

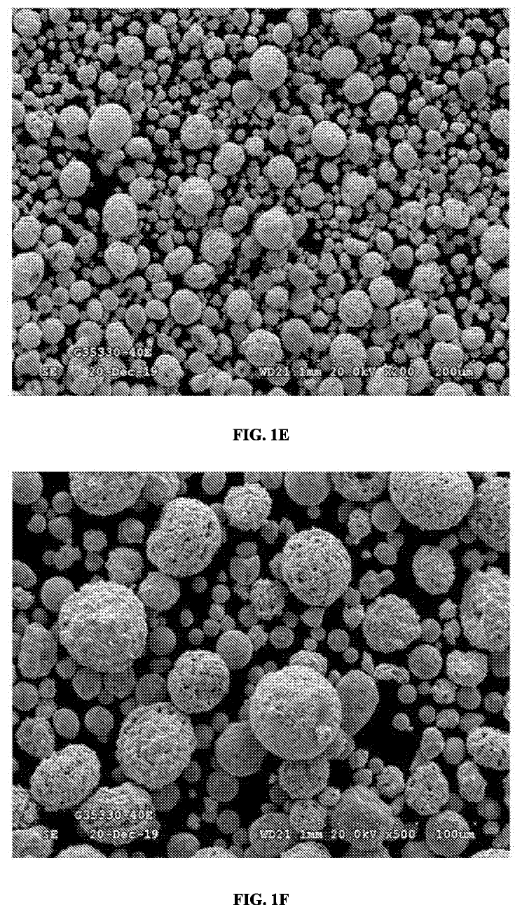

The SEM micrographs in FIG. 1A-1D clearly shows the spherical morphology of AM WC-A (FIGS. 1A-1B) and AM WC-B (FIGS. 1C-1D) powders. The spherical morphology contributes to good flowability of the powders.

Printing process: Samples of dimensions 25 mm×12 mm×8 mm and 77 mm×38 mm×13 mm were printed using a BJ3DP machine (Innovent, Exone, North Huntigndon, PA). The conditions used for printing the samples are shown in Table 3. The smaller size samples were used to evaluate the sintering characteristics of the powder and the mechanical properties of the cemented carbide. The larger size samples were used to evaluate the wear properties of the cemented carbide.

The binder saturation is defined as the ratio of volume occupied by the binder to the volume of open pores in the powder [P. Nandwana, Curr. Opin. Solid State Mater. Sci. 21, 4 (2017), 207-218]. AM WC-A, due to its lower bulk density, required higher binder saturation to obtain printed samples with good handling strength. After printing the samples were cured by heating to 200° C. in air. The curing process assists in improving the green/handling strength of the printed samples.

TABLE 3

| | Binder | Powder layer | Printing |
|---|---|---|---|
| | saturation | thickness | speed |
| Sample | (%) | (μm) | (mm/sec) |
| AM WC-A | 80 | 50 | 100 |
| AM WC-B | 45 | 50 | 100 |

Sintering process: The printed and cured samples were debound under a hydrogen atmosphere. To compensate for the loss of carbon, a carbon correction cycle involving introduction of methane gas along with hydrogen was run during the debinding of the samples till 800° C. After debinding the samples were heated to 1,375° C., 1,400° C., and 1,435° C. for sintering. The samples were held at the maximum temperature for 30 min. A pressure of 1.83 MPa (265 psi) was induced on the samples by Ar gas after holding for 30 minutes at the maximum sintering temperature. The pressure was induced for 30 minutes.

Properties of the sintered materials. 1. Mechanical Properties: The final density of the samples is shown in Table 4. Both samples reached near-theoretical density under the various sintering conditions. The samples made from AM WC-B achieved near theoretical density even at the lower sintering temperature of 1,375° C.

TABLE 4
Relative Density [g/cm³]

| | Sintering conditions | | |
|---|---|---|---|
| | 1,375° C./ | 1,400° C./ | 1,435° C./ |
| Powder | 30 min | 30 min | 30 min |
| AM WC-A | — | 100.0 | 100 |
| AM WC-B | 100.0 | 100.0 | 100.0 |

The pressure of 1.83 MPa used in the present study is significantly lower than the pressures used for densifying WC-Co parts using either sinter-HIP or hot isostatic pressing (HIP). Sinter-HIP processing of WC-Co parts is carried out by applying pressures up to 10 MPa and HIP is carried out at higher pressures of 12-150 MPa [ASM Specialty Handbook, Tool Materials, ASM International, 1995]. The sintered samples made from AM WC-A showed a shrinkage of 28.3-30.4% in length, 26.9-29.6% in width and 28.6-30.8% in thickness. On the other hand, the samples made from AM WC-B showed a lower shrinkage of 22.8-24.3% in length, 23.3-24.2% in width and 23.7-24.9% in thickness. The higher shrinkage of samples made from AM WC-A is expected, given its lower bulk density (Table 1).

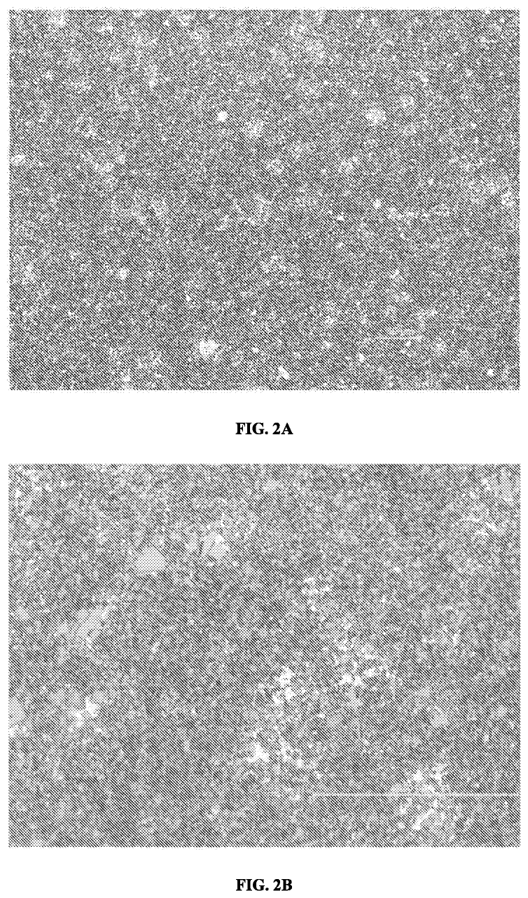

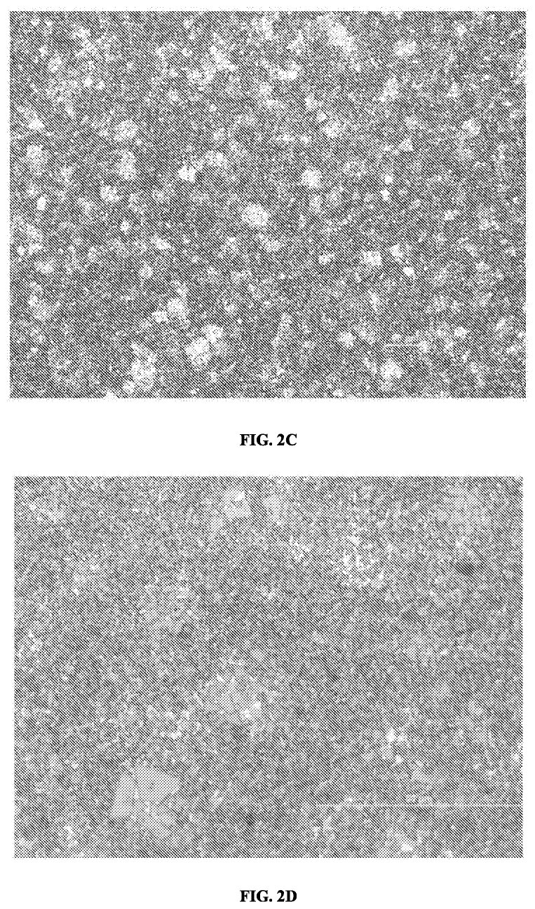

The sintered microstructures of AM WC-A (FIGS. 2A-2B) and AM WC-B (FIGS. 2C-2D) after sintering at 1,400° C. are shown in FIGS. 2A-2D. The microstructures show no porosity confirming the full densities in the sintered samples. The microstructure consists primarily of WC grains of medium size (1.4-2.0 μm) in a well distributed Co matrix. In AM WC-B clusters of coarse grains of size up to −20 μm are uniformly distributed throughout the microstructure.

The Rockwell hardness of the sintered samples are summarized in Table 5. The samples from both the powders showed hardness values close to 90 HRa.

TABLE 5
Hardness [HRa]

| | Sintering conditions | | |
|---|---|---|---|
| | 1,375° C./ | 1,400° C./ | 1435° C./ |
| Powder | 30 min | 30 min | 30 min |
| AM WC-A | — | 89.2 | 89.7 |
| AM WC-B | 89.6 | 89.4 | 89.5 |

| | |
|---|---|
| Conventional | 89.7 |
| PM | |

The fracture toughness of the sintered samples (Table 6) was determined using the indentation or Palmquist method.

Tables 5 and Table 6 also show the typical mechanical properties of a 12% Co cemented carbide of medium WC grain size (1.2-2.0 μm). It can be seen that the materials produced according to the present invention have mechanical properties (transverse rupture strength, hardness and fracture toughness) that match those of cemented carbides produced by conventional powder metallurgy.

TABLE 6
Fracture Toughness [MPa m^{3/2}]

| | Sintering conditions | | |
|---|---|---|---|
| | 1,375° C./ | 1,400° C./ | 1435° C./ |
| Powder | 30 min | 30 min | 30 min |
| AM WC-A | — | 15.2 ± 1.4 | 17 ± 1.2 |
| AM WC-B | 16.4 ± 1.4 | 16.3 ± 1.6 | 18.5 ± 1.7 |

| | |
|---|---|
| Conventional | 12 |
| PM | |

Wear Properties: The wear resistance of the samples sintered at 1,400° C. for 30 min was evaluated in the ASTM B611 abrasion wear test. Results are shown in Table 7.

TABLE 7
ASTM B611 Wear Test

| Powder | Volume Loss [mm³] |
|---|---|
| AM WC-A | 125 ± 5.2 |
| AM WC-B | 111.2 ± 0.7 |

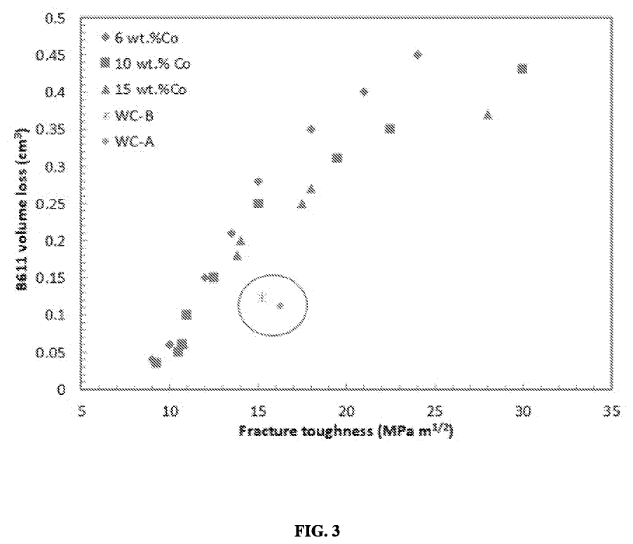

In the plot in FIG. 3 shows the wear resistance of AM WC-A and AM WC-B, shown in circled area of FIG. 3, is compared to the wear resistance of cemented carbides of varying Cobalt content produced by conventional powder metallurgy. The plot clearly shows superior wear resistance (lower volume loss) of AM WC-A and AM WC-B powders compared to other cemented carbides with similar fracture toughness. The volume loss of samples made from AM WC-A and AM WC-B powders was at least 50% lower compared to standard cemented carbide of similar fracture toughness.

Example 2: To produce a WC-12% Co powder suited for the BJ3DP process, a coarse powder (Global Tungsten & Powders Corp. SC75H and SC 75X with FSSS 20-40 μm) and a fine Co powder (Umicore extra fine powder with FSSS 1.2 μm) were utilized as raw materials. The WC and Co powders and cobalt acetate were milled to produce an aqueous slurry. The slurry was spray dried to produce spherical granules and followed by sintering the granules to remove the binder and to achieve some increase in the density of the granules through intra-granule sintering, while avoiding inter-granule sintering to preserve the spherical shape of the granules.

Spheriodization process: The sintered powder was then separated into size fractions by screening; the <150 μm fraction was fed through a powder feeder into a plasma torch and collected in water cooled tank. A mixture of gases like Hydrogen, Argon, Nitrogen etc. was fed to the plasma torch. Other gases can also be fed to the plasma torch.

Two powders identified as “AM WC-C” and “AM WC-D” were produced. AM WC-C was manufactured starting from SC75H carbide. AM WC-D was produced starting from SC75X carbide. The powder characteristics of AM WC-D are summarized in Table 8.

TABLE 8

| | Particle size (μm) | | | Bulk density | Carney flow |
|---|---|---|---|---|---|
| Sample | D10 | D50 | D90 | (g/cm³) | (s/200 g) |
| AM WC-D | 11.45 | 19.08 | 31.07 | 6.7 | 14 |

The chemical analysis of AM WC-D confirming high purity of the powders is shown in Table 9.

TABLE 9

| Element (%) | AM WC-D |
|---|---|
| C | 5.3 |
| Ca | <0.3 |
| Co | 12.5 |
| Cr | <0.1 |
| Cu | <0.2 |
| Fe | <0.1 |
| Mn | <0.2 |
| Mo | <0.2 |
| Nb | <0.2 |
| Ni | <0.1 |
| P | <0.1 |
| Ta | <0.2 |
| Ti | <0.3 |
| W | 82.2 |
| Zr | <0.1 |

The SEM micrographs in FIGS. 1E-1F clearly shows the spherical morphology of AM WC-C powders. The spherical morphology contributes to good flowability of the powders.

Printing process: Samples of dimensions 25 mm×12 mm×8 mm and 77 mm×38 mm×13 mm were printed using a BJ3DP machine (Innovent, Exone, North Huntigndon, PA). The conditions used for printing the samples are shown in Table 10. The smaller size samples were used to evaluate the sintering characteristics of the powder and the mechanical properties of the cemented carbide. The larger size samples were used to evaluate the wear properties of the cemented carbide.

After printing the samples were cured by heating to 200° C. in air. The curing process assists in improving the green/handling strength of the printed samples.

TABLE 10

| | Binder | Powder layer | Printing |
|---|---|---|---|
| | saturation | thickness | speed |
| Sample | (%) | (μm) | (mm/sec) |
| AM WC-C | 80 | 50 | 80-100 |
| AM WC-D | 80 | 50 | 80-100 |

Sintering process—over pressure sintering: The printed and cured samples were debound under a hydrogen atmosphere. To compensate for the loss of carbon, a carbon correction cycle involving introduction of methane gas along with hydrogen was run during the debinding of the samples till 800° C. After debinding the samples were heated to 1,435° C. for sintering. The samples were held at the maximum temperature for 30 min. A pressure of 1.83 MPa (265 psi) was induced on the samples by Ar gas after holding for 30 minutes at 1,435° C. The pressure was induced for 30 minutes.

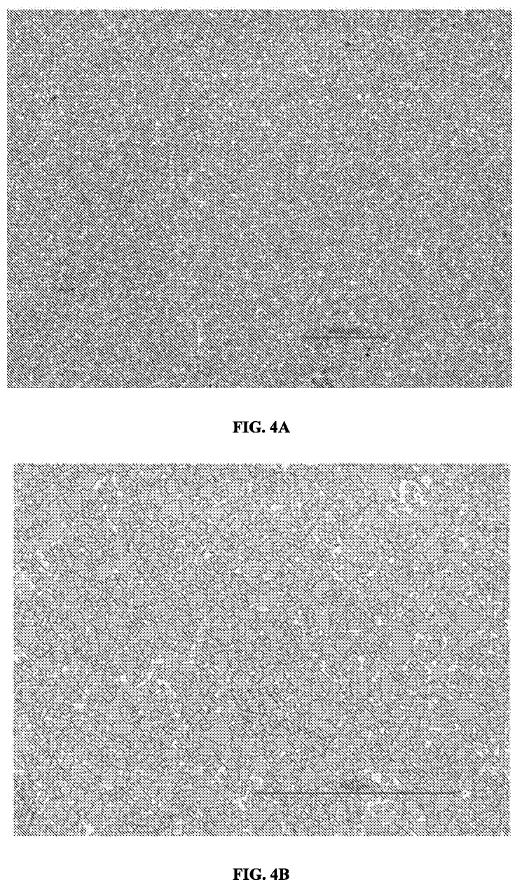

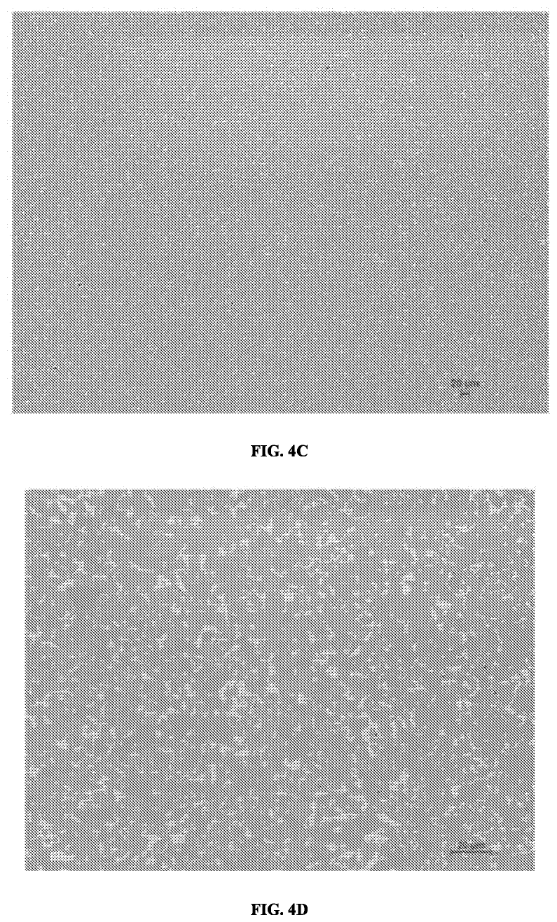

Sinter and mechanical Properties: The final density of the AM WC-C (FIGS. 4A and 4B) and AM WC-D (FIGS. 4C and 4D) samples after sintering was near theoretical density at 14.32 and 14.30 g/cm³. The sintered microstructures of the powders shown in FIGS. 4A-4D confirm full densification of the samples. The microstructures also display uniform distribution of WC in Co without any agglomeration of carbides. The microstructures exhibited by the sintered samples are identical to the microstructures of conventional cemented carbide carbides. The mechanical properties of the sintered samples are shown in Table 11 after sintering at 1,435° C. for 30 min.

TABLE 11

| | Hardness | TRS | Fracture Toughness |
|---|---|---|---|
| Sample | (Vickers) | (Mpa) | [MPa m^{3/2}] |
| AM WC-C | 1038 | 301 | 19.9 |
| AM WC-D | 993 | 247 | 20.7 |

Wear Properties: The wear resistance of the WC-C samples evaluated by ASTM B611, ASTM G65 and ASTM G76 is shown in Table 12 after sintering at 1,435° C. for 30 min.

TABLE 12

| ASTM B611 | ASTM G65 | ASTM G76 |
|---|---|---|
| (mm³) | (mm³) | (mm³) |
| 250.8 ± 1.6 | 2.95 ± 0.4 | 0.0027 |

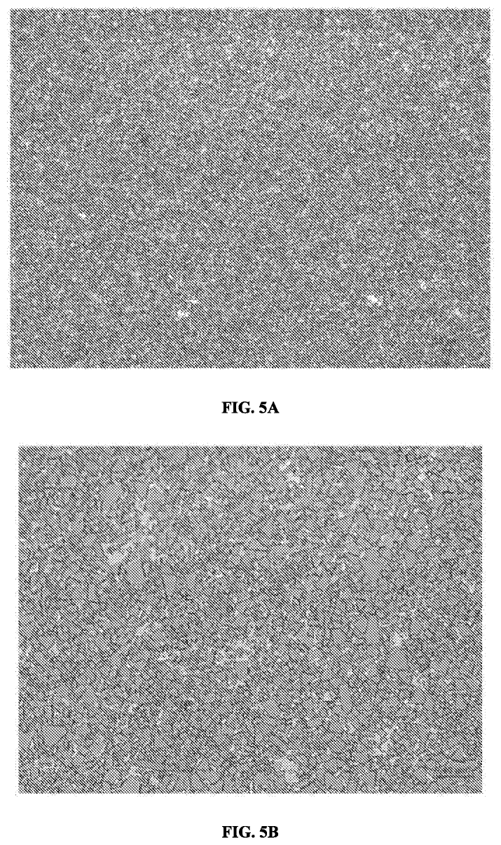

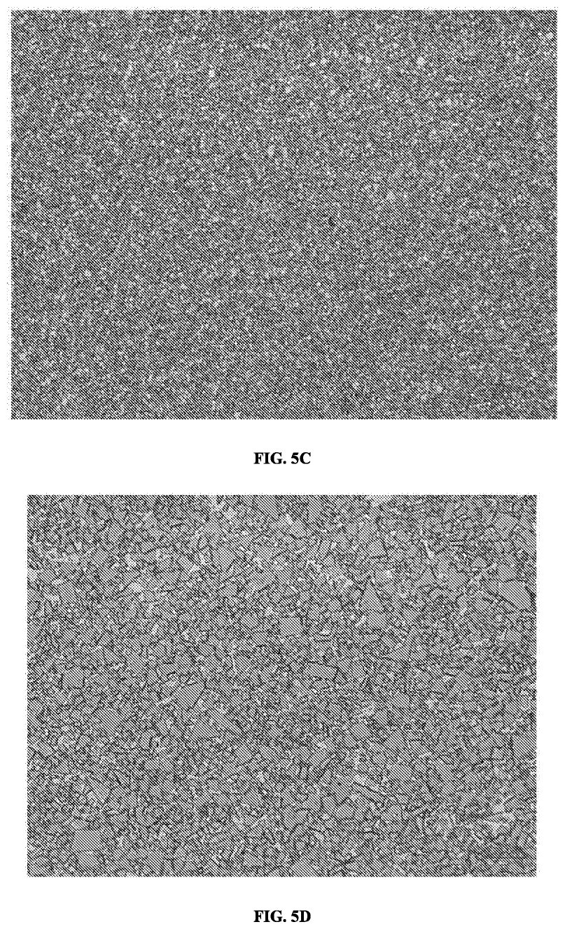

Vacuum sintering: The printed samples from WC-C and WC-D after debinding in hydrogen atmosphere were sintered to near full theoretical density in vacuum atmosphere without the requirement of external pressure. The samples from WC-C were sintered to full theoretical density in vacuum atmosphere at significantly lower temperature of 1,375° C. The ability to sinter samples to full theoretical density in vacuum atmosphere without the use of any external pressure and at low temperature will result in lower manufacturing costs for complex WC-Co parts manufactured via binder jet technology. The microstructure of the WC-C samples sintered in vacuum at 1,375° C. (FIGS. 5A and 5B), 1,400° C. (FIGS. 5C and 5D) and 1,435° C. (FIGS. 5E and 5F) confirm full densification of samples. The microstructures are also similar to the microstructures of conventional cemented carbides. The mechanical properties of the samples made from WC-C powders sintered in vacuum atmosphere are summarized in Table 13.

TABLE 13

| Temperature | Hardness | TRS | Fracture Toughness |
|---|---|---|---|
| (° C.) | (Ra) | (Mpa) | [MPa m^{3/2}] |
| 1375 | 85.9 | 281.3 ± 8.1 | 21.5 |
| 1400 | 86.1 | 276.7 ± 30 | 20.4 |
| 1435 | 86.0 | 309.7 ± 24.3 | 25.0 |

### Aspects

In view of the described composites and methods and variations thereof, herein below are described certain more particularly described aspects of the inventions. These particularly recited aspects should not however be interpreted to have any limiting effect on any different claims containing different or more general teachings described herein, or that the “particular” aspects are somehow limited in some way other than the inherent meanings of the language and formulas literally used therein

Aspect 1: A method comprising: a) densifying spherodized granules comprising tungsten carbide and a metallic binder phase in a plasma, thereby producing densified spherodized granules.

Aspect 2: The method of aspect 1, wherein the densified spherodized granules comprises at least about 75 wt % of tungsten carbide.

Aspect 3: The method of any one of aspects 1-2, wherein the densified spherodized granules comprises at least about 80 wt % of tungsten carbide.

Aspect 4: The method of any one of aspects 1-3, wherein the densified spherodized granules comprises at least about 2 wt % of the metallic binder phase.

Aspect 5: The method of any one of aspects 1-4, wherein the densified spherodized granules comprises at least about 10 wt % of the metallic binder phase.

Aspect 6: The method of any one of aspects 1-5, wherein the densified spherodized granules comprises from about 80 wt % to about 85 wt % of tungsten carbide and from about 10 wt % to about 15 wt % of the metallic binder phase.

Aspect 7: The method of any one of aspects 1-6, wherein the densified spherodized granules comprises at least about 2 wt % of carbon.

Aspect 8: The method of any one of aspects 1-7, wherein the densified spherodized granules comprises from about 83 wt % to about 93 wt % of tungsten carbide, from about 4 wt % to about 10 wt % of the metallic binder phase, and from about 3 wt % to about 7 wt % carbon

Aspect 9: The method of any one of aspects 1-8, wherein the metallic binder phase comprises Cr, Mo, Fe, Co, or Ni, or a combination thereof

Aspect 10: The method of any one of aspects 1-9, wherein the metallic binder phase comprises Co.

Aspect 11: The method of any one of aspects 1-10, wherein the densified spherodized granules has a particle size of D90 of less than 50 μm.

Aspect 12: The method of any one of aspects 1-10, wherein the densified spherodized granules has a particle size of D90 of less than 35 μm.

Aspect 13: The method of any one of aspects 1-12, wherein the densified spherodized granules has a bulk density of at least 4 g/cm³.

Aspect 14: A powder mixture for three-dimensional printing comprising the densified spherodized granules produced in any one of aspects 1-13.

Aspect 15: A method comprising: a) 3D printing a body from a composition comprising the powder mixture of aspect 14 and a printing binder.

Aspect 16: The method of aspect 15, wherein the composition comprises at least about 30% saturation of the printing binder.

Aspect 17: The method of any one of aspects 15-16, wherein the composition comprises at least about 40% saturation of the printing binder.

Aspect 18: The method of any one of aspects 15-17, wherein the composition comprises at least about 60% saturation of the printing binder.

Aspect 19: The method of any one of aspects 15-18, wherein the composition comprises about 100% saturation of the powder mixture.

Aspect 20: The method of any one of aspects 15-19, wherein the composition comprises at least about 60% saturation of the powder mixture.

Aspect 21: The method of any one of aspects 15-20, wherein the composition comprises at least about 40% saturation of the powder mixture.

Aspect 22: The method of any one of aspects 15-21, wherein the method further comprises the step of sintering the body, thereby producing a cemented carbide body or a cermet body.

Aspect 23: The method of aspect 22, wherein the sintering is performed at a temperature of at least 1,200° C.

Aspect 24: The method of aspect 22, wherein the sintering is performed at a temperature from about 1,300° C. to about 1,500° C.

Aspect 25: The method of any one of aspects 22-24, wherein the cemented carbide body or the cermet body has a relative density of at least 99.9% theoretical density.

Aspect 26: The method of any one of aspects 22-25, wherein the cemented carbide body or the cermet body has a relative density of at least 100.0% theoretical density.

Aspect 27: The method of any one of aspects 22-26, wherein the cemented carbide body or the cermet body has a hardness of at least 83.0 Hra.

Aspect 28: The method of any one of aspects 22-27, wherein the cemented carbide body or the cermet body has a fracture toughness of at least 3 Mpa m^{3/2}.

Aspect 29: The method of any one of aspects 22-28, wherein the cemented carbide body or the cermet body has a fracture toughness of at least 14 Mpa m^{3/2}.

Aspect 30: The method of any one of aspects 22-28, wherein the cemented carbide body or the cermet body has a fracture toughness of at least 16 Mpa m^{3/2}.

Aspect 31: The method of any one of aspects 22-30, wherein the cemented carbide body or the cermet body has a volume loss of less than 150 mm³ when evaluated in a ASTM B611 abrasion wear test.

Aspect 32: The method of any one of aspects 22-31, wherein the 3D printing is binder jetting.

Aspect 33: The method of any one of aspects 22-32, wherein the cemented carbide body or the cermet body is a cutting tool for metallic cutting, a cutting tool for mining application, a wear part, a flow control component for oil or gas applications, or is a pump component for oil and gas applications.

Aspect 34: A three-dimensional printed body of cemented carbide or cermet produced by the method of any one of aspects 22-33.

Aspect 35: The three-dimensional printed body of cemented carbide or cermet of any one of aspect 34, wherein it has a microstructure of the porosity classification A00B00C00.

Aspect 36: The three-dimensional printed body of cemented carbide or cermet of any one of aspect 34, wherein it has a duplex microstructure.

Aspect 37: A three-dimensional printed body of cemented carbide or cermet, wherein it has a duplex microstructure.

### REFERENCES

Ian Gibson, David Rosen, and Brent Stucker, Additive manufacturing technologies: 3D printing, rapid prototyping, and direct digital manufacturing: Springer, 2014.
P. Nandwana, A. M. Elliott, D. Siddel, A. Merriman, W. H. Peter, S. S. Babu, Powder bed binder jet 3D printing of Inconel 718: Densification, microstructural evolution and challenges, Curr. Opin. Solid State Mater. Sci. 21, 4 (2017), 207-218.
Daeho Hong, Da-Tren Chou, Oleg I. Velikokhatnyi, Abhijit Roy, Boeun Lee, Isaac Swink, Ilona Issaev, Howard A. Kuhn, Prashant N. Kumta, Binder-jetting 3D printing and alloy development of new biodegradable Fe—Mn—Ca/Mg alloys, Acta biomaterialia, 45, 2016, pp. 375-386.
Amir Mostafaei, Jakub Toman, Erica L. Stevens, Eamonn T. Hughes, Yuval L. Krimer, Markus Chmielus, Microstructural evolution and mechanical properties of differently heat-treated binder jet printed samples from gas- and water-atomized alloy 625 powders, Acta Materialia 124 (2017) 280-289.
Yun. Bai, Christopher B. Williams, An exploration of binder jetting of copper, Rapid Protot. J. 21 (2) (2015) 177-185.
J. P. Kruth, L. Froyen, J. Van Vaerenbergh, P. Mercelis, M. Rombouts, and B. Lauwers, “Selective laser melting of iron-based powder”, Mater. Process. Technol., 2004, vol. 149, no. 1-3, pp. 616-622.
M. Fousovaa, D. Vojtecha, J. Kubaseka, E. Jablonskab and J. Fojta. “Promising characteristics of gradient porosity Ti-6A1-4V alloy prepared by SLM process”, J Mech Behav. Biomed., 2017, vol. 201, no. 69, pp. 368-76.
E. O. Olakanmi, R. F. Cochrane and K. W Dalgarno, “Densification mechanism and microstructural evolution in selective laser sintering of A1-12Si powders”, J. Mater. Process. Technol., 2011, vol. 211, no 0.1, pp. 113-121.
Y. M. Arisoy, L. E. Criales, T. Özel, B. Lane, S. Moylan and A. Donmez, “Influence of scan strategy and process parameters on microstructure and its optimization in additively manufactured nickel alloy 625 via laser powder bed fusion”, Int. J. Adv. Manuf Tech, 2017, vol. 90, no. 5-8, pp. 1393-1417
Q. Jia, D. Gu. “Selective laser melting additive manufacturing of Inconel 718 superalloy parts: Densification, microstructure and properties”, J. Alloys Compd. 2014; 585:713-721.
Ravi K. Enneti, Kevin Prough, Ajay Krishnan, Scott Volk, “Direct metal laser sintering (DMLS)/selective laser melting (SLM) of WC-12% Co powders” 2018 AMPM conference, San Antonio, USA.
Subrata Kumar Ghosh, Alok Kumar Das, and Partha Saha, “Selective Laser Sintering: A Case Study of Tungsten Carbide and Cobalt Powder Sintering by Pulsed Nd: YAG Laser,” in In Lasers Based Manufacturing. India: Springer, 2015, pp. 441-459.
P. Stoyanov and P. Prichard., “Methods of Making Sintered Articles”, U.S. Published Patent Application 2019/0084290 A1, 2019.
P. Prichard and G. Collins, “Cemented Carbide Powders for Additive Manufacturing”, U.S. Published Patent Application 2018/0236687 A1, 2018.
C. Maderud and J. Sundstrom, “Method of Making Cermet or Cemented Carbide Powder”, U.S. Published Patent Application 2017/0072469 A1, 2017.
C. Maderud and J. De Flon, “Three Dimensional Printing of Cermet or Cemented Carbide”, PCT Published Patent Application WO 2017/178319 A1.
I. Konyashin, B. Ries, D. Hlawatschek, Y. Zhuk, A. Mazilkin, B. Straumal, F. Dorn, D. Park, Wear-resistance and hardness: Are they directly related for nanostructured hard materials? Int. J. Refract. Met. Hard Mater. 49 (2015) 203-211.
ASM Specialty Handbook, Tool Materials, ASM International, 1995.

1. A method comprising:
a. densifying spherodized granules comprising tungsten carbide and a metallic binder phase in a plasma, thereby producing densified spherodized granules.

2. The method of claim 1, wherein the densified spherodized granules comprises at least about 75 wt % of tungsten carbide.

3. The method of claim 1, wherein the densified spherodized granules comprises at least about 80 wt % of tungsten carbide.

4. The method of claim 1, wherein the densified spherodized granules comprises at least about 2 wt % of the metallic binder phase.

5. The method of claim 1, wherein the densified spherodized granules comprises at least about 10 wt % of the metallic binder phase.

6. The method of claim 1, wherein the densified spherodized granules comprises from about 80 wt % to about 85 wt % of tungsten carbide and from about 10 wt % to about 15 wt % of the metallic binder phase.

7. The method of claim 1, wherein the densified spherodized granules comprises at least about 2 wt % of carbon.

8. The method of claim 1, wherein the densified spherodized granules comprises from about 85 wt % to about 96 wt % of tungsten carbide, from about 4 wt % to about 15 wt % of the metallic binder phase.

9. The method of claim 1, wherein the metallic binder phase comprises Cr, Mo, Fe, Co, or Ni, or a combination thereof.

10. The method of claim 1, wherein the metallic binder phase comprises Co.

11. The method of claim 1, wherein the densified spherodized granules has a particle size of D90 of less than 50 μm.

12. The method of claim 1, wherein the densified spherodized granules has a particle size of D90 of less than 35 μm.

13. The method of claim 1, wherein the densified spherodized granules has a bulk density of at least 4 g/cm³.

14. A powder mixture for three-dimensional printing comprising the densified spherodized granules produced in claim 1.

15. A method comprising:
a. 3D printing a body from a composition comprising the powder mixture of claim 14 and a printing binder.

16. (canceled)

17. (canceled)

18. The method of claim 15, wherein the composition comprises at least about 60% saturation of the printing binder.

19. (canceled)

20. The method of claim 15, wherein the composition comprises at least about 60% saturation of the powder mixture.

21. (canceled)

22. The method of claim 15, wherein the method further comprises the step of sintering the body, thereby producing a cemented carbide body or a cermet body.

23. (canceled)

24. (canceled)

25. The method of claim 22, wherein the cemented carbide body or the cermet body has a relative density of at least 99.9% theoretical density.

26. (canceled)

27. (canceled)

28. (canceled)

29. (canceled)

30. The method of claim 22, wherein the cemented carbide body or the cermet body has a fracture toughness of at least 16 Mpa m^{3/2}.

31.-37. (canceled)
